(19) United States
(12) Patent Application Publication
(10) Pub. No.: US 2006/0018534 A1
(43) Pub. Date: Jan. 26, 2006

(54) Technique for detecting a defect of an object by area segmentation of a color image of the object

(75) Inventors: Yasushi Nagata, Kyoto (JP); Atsushi Imamura, Kyoto (JP); Hiroshi Sano, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/152,115

(22) Filed: Jun. 15, 2005

(30) Foreign Application Priority Data
Jul. 26, 2004 (JP) 2004-217598

(51) Int. Cl. G06K 9/34

(52) U.S. Cl. 382/164

(57) ABSTRACT

The present invention provides a technique to prevent increase in defect detection processing volume due to the shape of an object subject to the defect detection. An image of an object under inspection with a plurality of color regions is divided into areas by area segmentation according to colors. From the result of the segmentation, an inspection image representing a shape of a specific region among the plurality of color regions is obtained. The inspection image and a comparison image which is comparable at least in part with the inspection image are then compared to detect defects relating to the specific region.

### CROSS-REFERENCE TO RELATED APPLICATIONS

The present application claims the priority based on Japanese Patent Application No. 2004-217598 filed on Jul. 26, 2004, the disclosure of which is hereby incorporated herein by reference in its entirety.

### BACKGROUND OF THE INVENTION

1. Field of the Invention

This invention relates to technique for detecting a defect of an object under inspection by means of area segmenting of an image.

2. Description of the Related Art

Printed circuit boards used in production of electronic circuitry are provided with through-holes for connectivity among layers and for mounting of components. Anomaly in position or shape of the through-holes, or anomaly such as blockage of the through-holes, may cause electrical continuity failure and failure to properly mount components. To detect such anomaly or defect potentially occurring in the through-holes, various inspection devices such as an apparatus disclosed in JP08-191185A are proposed.

However, when detecting a defect in the through-holes with some kind of inspection devices, it is necessary to extract characteristic quantities such as planar dimension and circumferential length for each of the individual through-holes provided in the printed circuit board. As a result, the processing volume entailed in the inspection process increases with increase of number of the through-holes provided in the printed circuit board. Although this problem is particularly notable in defect detection of the through-holes with some kind of inspection devices, it is a problem common to defect detection of objects subject to the inspection in general.

### SUMMARY OF THE INVENTION

An object of the present invention is to prevent increase in defect detection processing volume due to the shape of an object subject to the defect detection.

According to an aspect of the present invention, a method of detecting a defect relating to a specific region among a plurality of color regions, using a color image of an object under inspection having the plurality of color regions is provided. The method comprises the steps of: (a) performing segmentation of the color image into areas according to colors; (b) obtaining an inspection image representing a shape of the specific region from a result of the segmentation; and (c) detecting a defect relating to the specific region by comparing the inspection image with a comparison image, the comparison image being comparable at least in part with the inspection image.

In this arrangement, defects relating to the specific region can be detected by means of comparing the inspection image generated by area segmentation of the color image with the comparison image. In consequence, the processing volume entailed in detecting a defect may be reduced, even in instances where the object subject to the defect detection has a complex shape.

The present invention may be realized in various aspects, for example, a method and a device for obtaining position of surface region on an object, an inspection method and device employing that obtained result, a computer program for realizing the functions of these kinds of methods or devices, a recording medium on which that computer program is recorded, data signals embodied within carrier waves including that computer program, and the like.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates the configuration of a printed circuit board tester 100 as an embodiment of the present invention.

FIG. 2 illustrates a defect-free printed circuit board PCB.

FIG. 3 is a flowchart showing the procedure for inspecting the individual printed circuit board PCB in the first embodiment.

FIG. 4A illustrates a color image IM1 of a printed circuit board PCB with through-hole defects.

FIG. 4B depicts the segmentation result SR1 of the color image IM1.

FIG. 5A through FIG. 5F illustrate the way of the inspection of the printed circuit board PCB.

FIG. 6 is a flowchart showing the procedure for inspecting the printed circuit board PCB in the second embodiment.

FIG. 7A illustrates a color image IM2 of a printed circuit board PCB with through-hole defects.

FIG. 7B depicts the segmentation result SR2 of the color image IM2.

FIG. 8A through FIG. 8F illustrate the way of the inspection of the printed circuit board PCB.

### DESCRIPTION OF THE PREFERRED EMBODIMENT

Embodiments of the present invention will now be described in the following sequence.
A. First Embodiment:
B. Second Embodiment:
C. Modifications:

### A. First Embodiment

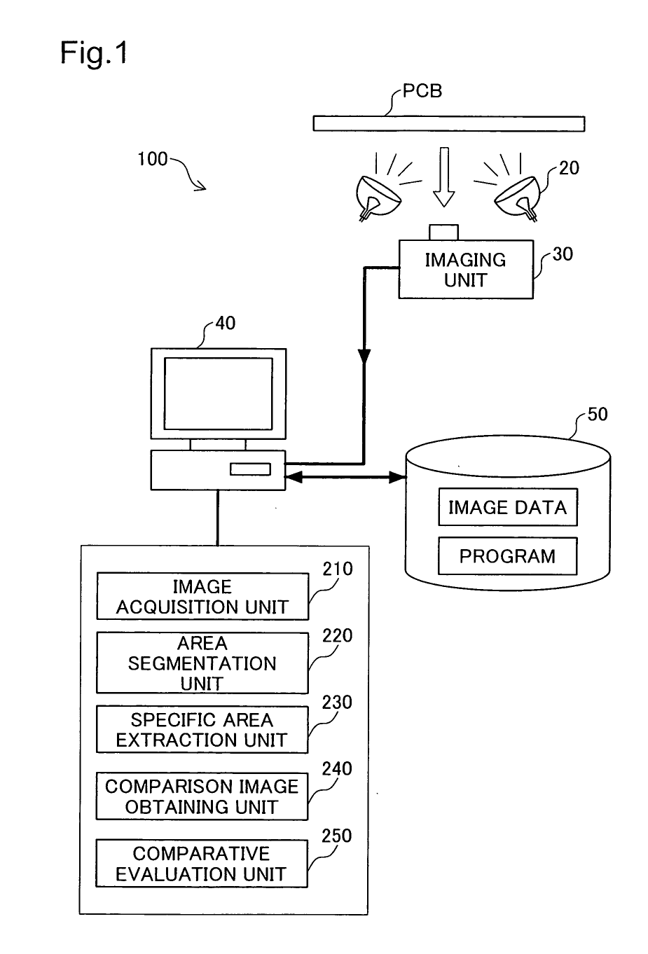

FIG. 1 illustrates the configuration of a printed circuit board tester 100 as an embodiment of the present invention. This printed circuit board tester 100 comprises a light source 20 for illuminating a printed circuit board PCB, an imaging unit 30 for capturing an image of the printed circuit board PCB, and a computer 40 for performing control of the overall devices. The computer 40 is connected to an external storage device 50 for storing various data such as an image data and a computer program.

The computer 40 has the functions of an image acquisition unit 210, an area segmentation unit 220, a specific area extraction unit 230, a comparison image obtaining unit 240, and a comparative evaluation unit 250. The functions of these units are realized through execution of a computer program stored on the external storage device 50 by the computer 40.

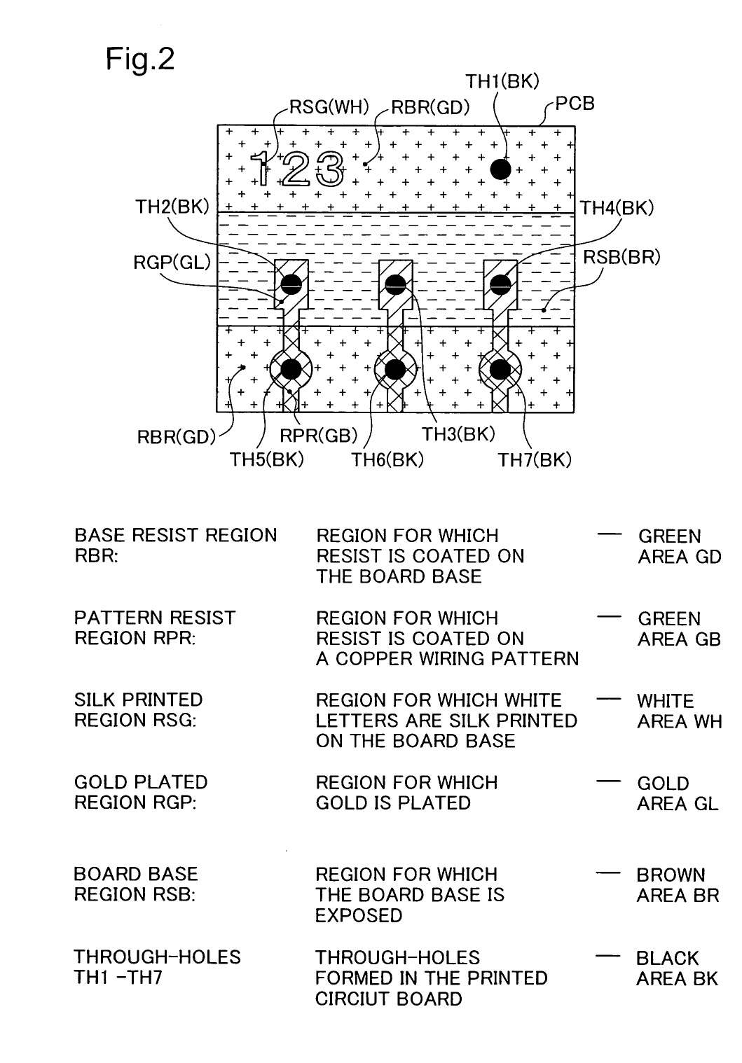

FIG. 2 illustrates a defect-free printed circuit board PCB (hereinafter termed “master board”). The surface of the printed circuit board PCB includes base resist regions RBR for which resist is coated on the board base, pattern resist regions RPR for which resist is coated on a copper wiring pattern, a silk printed region RSG for which white letters are silk printed on the board base, gold plated regions RGP for which gold is plated, and a board base region RSB for which the board base is exposed. Seven through-holes TH1˜TH7 are formed in the printed circuit board PCB.

In the image of the defect-free printed circuit board PCB captured by the imaging unit 30 (FIG. 1), the base resist regions RBR are represented as dark green areas GD, because the brown board base is coated with green colored resist for the base resist regions RBR. The pattern resist regions RPR are represented as bright green areas GB brighter than the base resist regions RBR, because the copper-colored copper wiring pattern underlies the resist in the pattern resist regions RPR. The silk printed region RSG, the gold plated regions RGP, and the board base region RSB are represented as a white area WH, a gold area GL, and a brown area BR respectively, which have the colors of their respective surface materials. Since the through-holes TH1˜TH7 consist of open holes in the board, the through-holes TH1˜TH7 are represented as black areas BK. The image of the master board is acquired in advance prior to inspection of an individual printed circuit board, and stored in the external storage device 50.

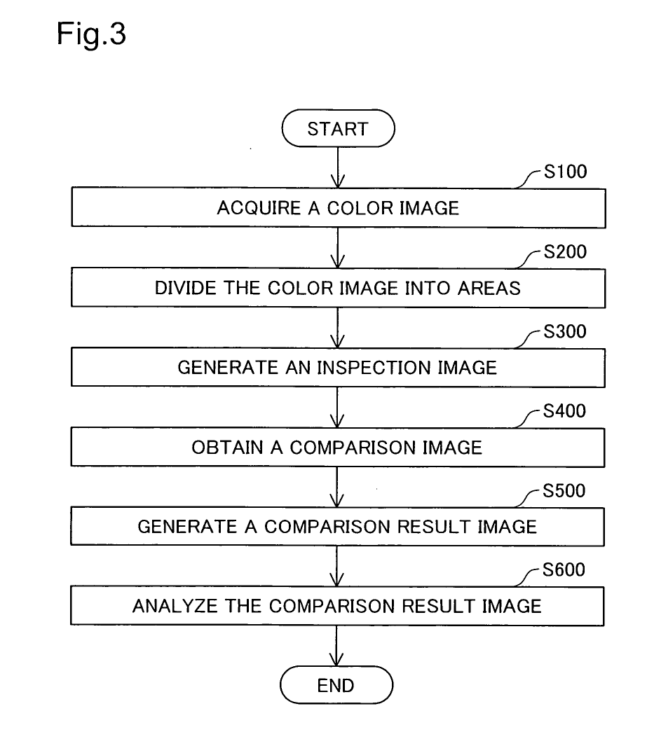

FIG. 3 is a flowchart showing the procedure for inspecting the individual printed circuit board PCB in the first embodiment. At Step S100, the image acquisition unit 210 (FIG. 1) acquires a color image of a printed circuit board PCB from the imaging unit 30 (FIG. 1). When procedure after step S200 is executed with respect to an image acquired in advance, image data is read from the external storage device 50 (FIG. 1) at step S100.

At Step S200, the area segmentation unit 220 (FIG. 1) divides the acquired color image into areas according to colors. Segmentation of the color image into areas according to colors may be carried out as follows, for example. First, a plurality of areas appearing in the image is specified, and colors representing characteristics of the areas are selected as representative colors. A distance index values that represent distance of the point representing the color of each pixel of the image from points representing a plurality of representative colors in a predetermined color space is then derived. By classifying pixels into areas of representative color that minimize this distance index value, the color image is divided into areas according to colors. As the distance index value it is possible to use, for example, Euclidean distance where the RGB color space is assumed as a three-dimensional Euclidean space, or color difference ΔE in the L*a*b* color space. Any segmentation method is employable for the segmentation carried out at step S200 when it is possible to classify the pixels of a color image into a plurality of areas according to colors. For example, such as the method disclosed in JP2002-259667A is also employable.

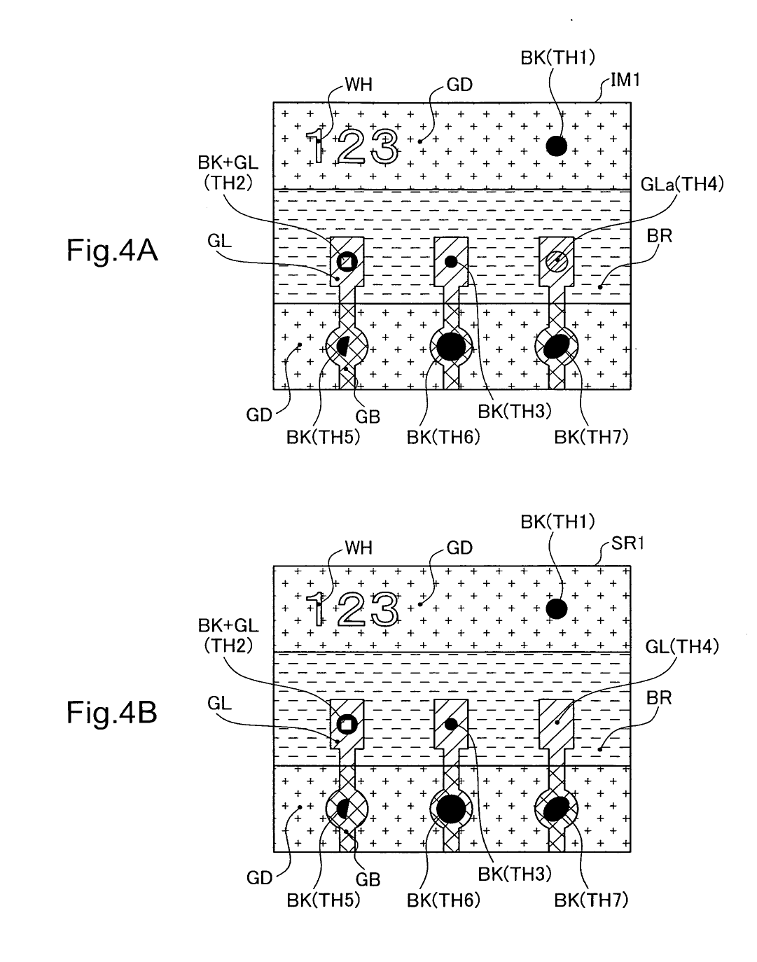

FIG. 4A illustrates a color image IM1 of a printed circuit board PCB with through-hole defects. FIG. 4B depicts the segmentation result SR1 of the color image IM1. As described hereinbelow, the printed circuit board PCB represented by the color image IM1 has defects in six through-holes TH2˜TH7 of seven through-holes TH1˜TH7.

Foreign matter (gold) exists at the center of the through-hole TH2. Thus, a gold area GL appears at the center of the black area BK representing the through-hole TH2. The hole diameter of the through-hole TH3 is smaller than normal, so the black area BK representing the through-hole TH3 is smaller than the black area BK representing the defect-free through-hole TH1. For the through-hole TH4, since the hole is obstructed by gold (termed “hole blockage”), the through-hole TH4 is represented as a gold area GLa slightly darker than the surrounding gold area GL. For the through-hole TH5, since the hole is partially covered by the resist (termed “resist coverage”), the black area BK representing the through-hole TH5 is of semi-circular shape in the part thereof not covered over by the resist. The diameter of the through-hole TH6 is larger than normal, so the black area BK representing the through-hole TH6 is larger than the black area BK representing the through-hole TH1. The through-hole TH7 has a defect whereby the hole shape has flattened deformation. Thus, the black area BK representing the through-hole TH7 differs in shape from the black area BK representing the through-hole TH1.

By means of the area segmentation carried out at step S200 (FIG. 3), the color image IM1 is divided into six areas GD, GB, WH, GL, BR, BK as shown by the segmentation result SR1 of FIG. 4B. The color of the gold area GLa representing through-hole TH4 in the color image IM1 has a color that approximates the color of the gold area GL representing the gold plated regions RGP. Thus, in the segmentation result SR1, the through-hole TH4 part is assigned to the same area GL as the surrounding gold plated region RGP.

At step S300 of FIG. 3, the specific area extraction unit 230 (FIG. 1) generates an inspection image from the segmentation result. Specifically, the specific area extraction unit 230 extracts the black areas BK representing the through-holes of the printed circuit board PCB from the segmentation result. The image representing the shapes of the extracted black areas BK serves as the inspection image.

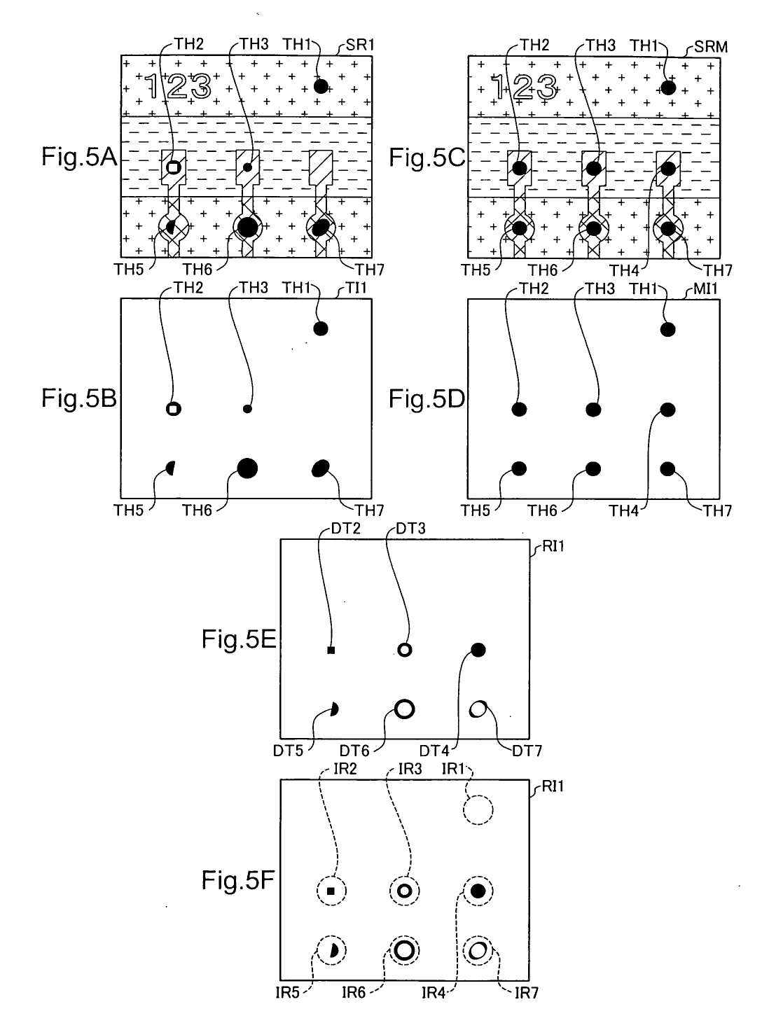

FIG. 5A shows the segmentation result SR1 generated by segmentation of the color image IM1. FIG. 5A is the same as FIG. 4B. FIG. 5B shows an inspection image TI1 generated from the segmentation result SR1 shown in FIG. 5A. This inspection image TI1 is a binary image in which the black areas BK of the segmentation result SR1 are black, and areas other than the black areas BK are rendered as white.

At step S400, the comparison image obtaining unit 240 (FIG. 1) obtains a comparison image for comparing with the inspection image. Specifically, the comparison image obtaining unit 240 reads a comparison image generated and stored in the external storage device 50 (FIG. 1) in advance from the external storage device 50.

The comparison image may be generated by means of a procedure similar to steps from S100 to S300 described above. Specifically, a color image of a defect-free printed circuit board PCB (FIG. 2) is acquired, and the color image is divided into areas to obtain a segmentation result. A segmentation result SRM obtained in this manner is shown in FIG. 5C. As shown in FIG. 5C, this segmentation result SRM is also divided into six areas GD, GB, WH, GL, BR, BK.

The comparison image is generated by extracting the black areas BK representing the through-holes of the printed circuit board PCB from the segmentation result SRM. FIG. 5D shows the comparison image MI1 generated from the segmentation result SRM shown in FIG. 5C. This comparison image MI1 is a binary image in which the black areas BK of the segmentation result SRM are black, and areas other than the black areas BK are rendered as white.

In the first embodiment, the comparison image is generated from an image of a defect-free printed circuit board. It is also possible to obtain the comparison image by some other method. For example, a comparison image is also possible to obtain by acquiring images of a plurality of printed circuit boards and generating a comparison image on the basis of the cumulative frequency of appearance of black color representing the through-holes. It is also possible to obtain a comparison image in accordance with the information on through-hole location and through-hole size contained in the design data (CAD data) used for forming the through-holes.

At step S500 of FIG. 3, the comparative evaluation unit 250 (FIG. 1) generates a comparison result image from the inspection image and the comparison image. Specifically, by the operation of exclusive-OR between the inspection image and the comparison image, a comparison result image representing difference between these two images is obtained. FIG. 5E shows the comparison result image RII obtained by the operation of exclusive-OR between the inspection image TI1 shown in FIG. 5B and the comparison image MI1 shown in FIG. 5D. In this way, the comparison result image RI1 being a binary image in which the through-hole defects DT2˜DT7 are represented by black is obtained.

When performing the operation of exclusive-OR between the inspection image TI1 and the comparison image MI1, a process for correcting displacement of the two images TI1, MI1 may be carried out. This correction may be carried out by shifting at least one of the two images TI1, MI1 in order to acquire a relative shift amount that minimizes the displacement of the two images TI1, MI1 (the process is also called as a “shaking process”), and correcting the displacement in accordance with the acquired shift amount. In this case, the level of relative shift for minimizing the displacement of the two images TI1, MI1 may be set to the relative shift amount at which the number of black pixels in the comparison result image RI1 is smallest, for example.

At step S600 of FIG. 3, the comparative evaluation unit 250 analyzes the comparison result image RI1 in order to determine whether a defect exists in each through-hole. Specifically, an inspection area is established at each through-hole, and the planar dimension of a defect appearing in an inspection area is evaluated to determine whether a defect exists.

FIG. 5F depicts inspection areas IR1˜IR7 corresponding to the through-holes TH1˜TH7. These inspection areas IR1˜IR7 may be derived, for example, by a process of “spreading” (expansion process) the black areas representing the through-holes TH1˜TH7 in the comparison image MI1. It is also possible to establish the inspection areas in accordance with the information on through-hole location and through-hole size included in CAD data.

The following criteria may be employed in determining whether a defect exists in a through-hole.

(1) In the event that the planar dimension of a defect in an individual inspection area exceeds a criterion dimension of defect, it is determined that the corresponding through-hole has a defect.

(2) A weighted planar dimension of which weight is set according to defect location in the inspection area is employable as the planar dimension of the defect of criterion (1) above. It is preferable to assign the grater weight for the center portion of an inspection area, which is highly affected by a defect, than the weight assigned for the peripheral portion of the same inspection area.

(3) In the event that a defect is a hole diameter anomaly as with through-holes TH3, TH6 (FIG. 4A), existence of a defect is determined on the basis of the width of the circles DT3, DT6 appearing in the comparison result image RI1.

(4) In the event that a defect is deformation as with through-hole TH7 (FIG. 4A), existence of a defect is determined on the basis of the number of defects and the total planar dimension of defects appearing in the comparison result image RI1.

In the first embodiment, the aforementioned criterion (1) is used, but any one or more criteria selected from criteria (1)˜(4) may be used for the determination. It is also possible to use determination criteria other than these as well.

As shown in FIG. 5F, inspection areas IR2˜IR7 contain black areas DT2˜DT7 (FIG. 5E) indicating that there are defects. Thus, the comparative evaluation unit 250 determines that defects exist in the through-holes TH2˜TH7 corresponding to these inspection areas IR2˜IR7. The inspection area IR1, on the other hand, does not contain a black area indicating the existence of a defect. Thus, the comparative evaluation unit 250 determines that no defect exists in the through-hole TH1 corresponding to the inspection area IR1.

In this way, according to the first embodiment, it is possible to detect a defect relating to a through-hole by comparing a comparison image with an inspection image generated by area segmentation of a color image.

In the first embodiment, inspection areas are established for individual through-holes. It is also acceptable to establish a inspection area that includes areas corresponding to a plurality of through-holes. Alternatively, the total planar dimension of defects appearing in the comparison result image RI1 may be evaluated for the inspection, without establishing an inspection area. However, the approach of establishing inspection areas for individual through-holes is preferred for its greater accuracy in detection of a through-hole defect.

### B. Second Embodiment

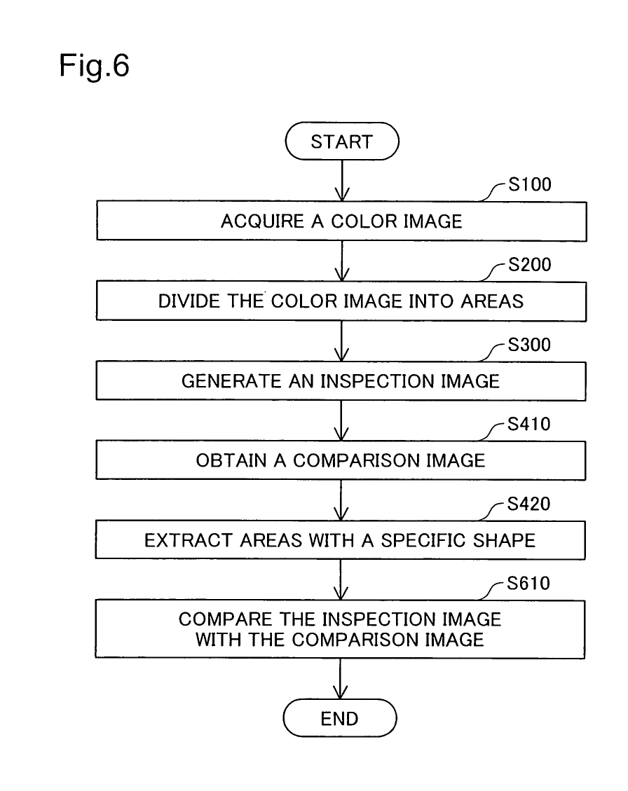

FIG. 6 is a flowchart showing the procedure for inspecting the printed circuit board PCB in the second embodiment. It differs from the flowchart of the first embodiment shown in FIG. 3 in that Step S400 is replaced with Steps S410 and S420, Step S600 is replaced with Step S610, and Step S500 is omitted. In other respects it is the same as the first embodiment.

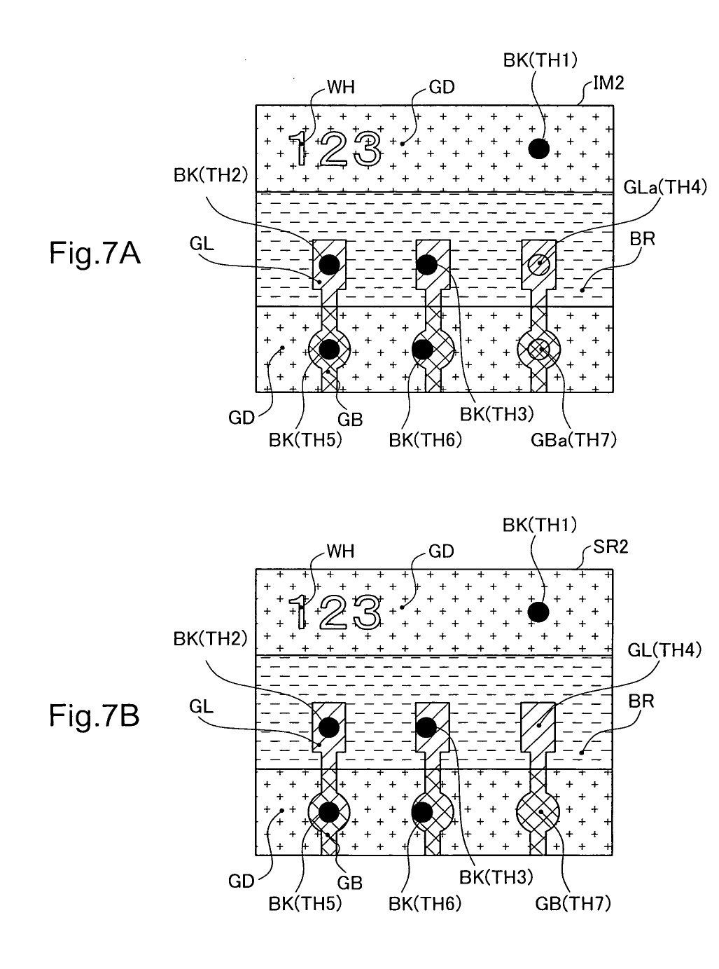

FIG. 7A illustrates a color image IM2 of a printed circuit board PCB with through-hole defects, acquired at step S100. FIG. 7B depicts the segmentation result SR2 of the color image IM2 performed at step S200. As shown in FIG. 7A, the printed circuit board PCB represented by the color image IM2 has defects in four through-holes TH3, TH4, TH6, TH7 of the seven through-holes TH1˜TH7.

The through-holes TH3, TH6 displace to the left from their proper location. The through-hole TH3 of which left edge contacts the brown area BR (board base region RSB) and the through-hole TH6 of which left edge contacts the green area GD (base resist region RBR) are in the state of land breakout. The through-holes TH4, TH7 experience the blockage due to being obstructed by gold or copper. Thus, the through-hole TH4 is represented as a gold area GLa slightly darker than the surrounding gold area GL, and the through-hole TH7 is represented as a green area GBa slightly darker than the surrounding green area GB.

By carrying out area segmentation at step S200 (FIG. 6), the color image IM2 is divided into six areas GD, GB, WH, GL, BR, BK as shown in segmentation result SR2. Since the color of the gold area GLa representing the through-hole TH4 approximates the color of the gold area GL representing the gold plated regions RGP, the area representing the through-hole TH4 is classified to the same gold area GL as the surrounding area. Similarly, the area representing the through-hole TH7 is classified to the same green area GB as the surrounding area.

At step S300 of FIG. 6, the specific area extraction unit 230 (FIG. 1) generates an inspection image from the segmentation result. Specifically, the specific area extraction unit 230 extracts the black areas BK representing the through-holes of the printed circuit board PCB from the segmentation result. The image representing the shapes of the extracted black areas BK serves as the inspection image.

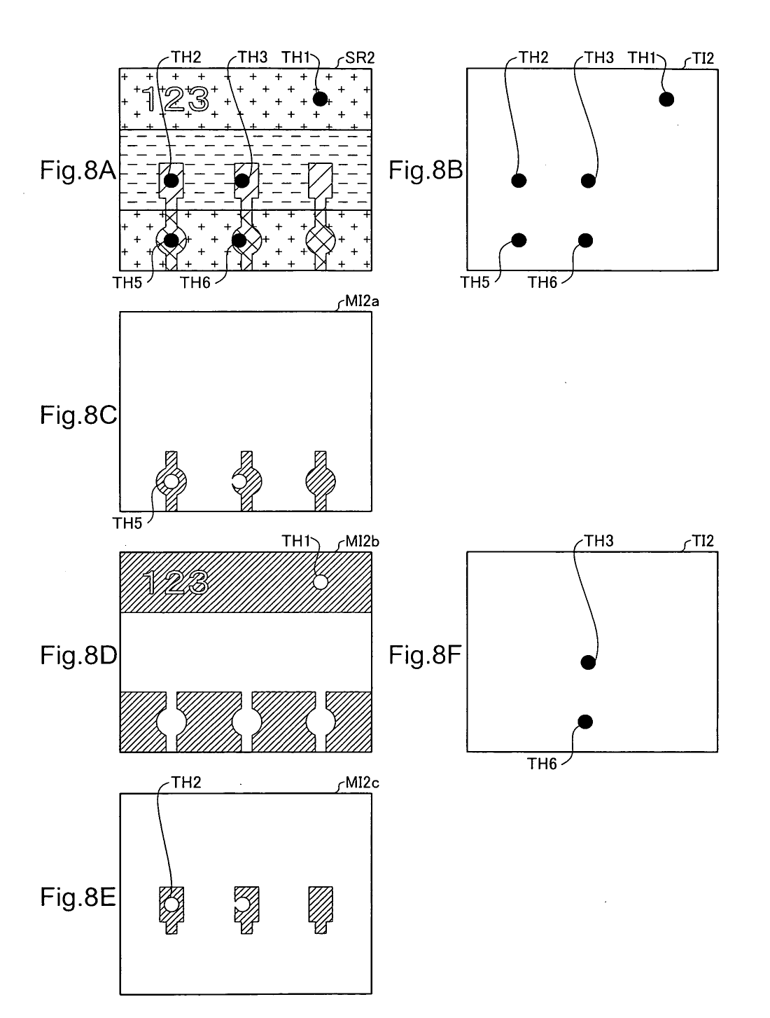

FIG. 8A shows the segmentation result SR2 generated by segmentation of the color image IM2. FIG. 8A is the same as FIG. 7B. FIG. 8B shows an inspection image TI2 generated at step S300 (FIG. 6) from the segmentation result SR2 shown in FIG. 8A. This inspection image TI2 is a binary image in which the black areas BK of the segmentation result SR2 are black, with areas other than the black areas BK rendered as white. In the inspection image TI2, there appear areas corresponding to five through-holes TH1˜TH3, TH5 and TH6.

At step S410 of FIG. 6, the comparison image obtaining unit 240 obtains the color areas GB, GD, GL which are not black areas BK from the segmentation result SR2 shown in FIG. 8A. FIG. 8C shows a first comparison image MI2a representing the shape of the green area GB extracted from the segmentation result SR2. In this comparison image MI2a, the extracted green area GB is represented by hatching. Similarly, the hatched areas in the second comparison image MI2b shown in FIG. 8D and the third comparison image MI2c shown in FIG. 8E respectively represent the extracted green area GD and gold area GL.

At step S420, the comparison image obtaining unit 240 extracts circular areas from each of the three comparison images MI2a˜MI2c. In FIG. 8C, a circular area at the location of the through-hole TH5 is extracted. Similarly, circular areas at the locations of the through-hole TH1 and the through-hole TH2 are respectively extracted from the second comparison image MI2b shown in FIG. 8D and the third comparison image MI2c shown in FIG. 8E.

The “circular area” herein refers to an area whose contour is enclosed by a circle, and differing from a true circle by no more than a predetermined tolerance range. In the second embodiment, the circular area is an area having a predetermined relationship of maximum diameter R to circumferential length l (e.g. 2.8≦l/R≦3.4), extracted from non-hatched areas of the comparison images MI2a˜MI2c. The extraction of circular areas is also able to carry out by some other method. In this case, circular areas may be extracted on the basis of non-hatched area circumferential length, center of mass, radius, aspect ratio, planar dimension, circularity, and so on.

At step S610, circular areas extracted from the three comparison images MI2a˜MI2c in this way are compared to the through holes extracted from the inspection image TI2, to determine whether a defect exists. Specifically, in the event that a circular area corresponding to a through-hole exists in the comparison image, it is determined that that through-hole is free of defects. On the other hand, if a circular area corresponding to a through-hole does not exist, it is determined that that there is a defect in the through-hole. In the example of FIG. 8A through FIG. 8F, of the through-holes TH1˜TH3, TH5, TH6 extracted from the inspection image TI2, circular areas corresponding to the through-holes TH1, TH2, and TH5 exist in the comparison images MI2a˜MI2c. Therefore, it is determined that through-holes TH1, TH2, and TH5 are free of defects. For the through-holes TH3 and TH6, on the other hand, corresponding circular areas are not exist. Therefore, it is determined that the through-holes TH3 and TH6 have defects. In this way, in the second embodiment, only the through-holes TH1˜TH3, TH5, TH6 which are part of the inspection image TI2 shown in FIG. 8B are compared with the comparison images MI2a˜MI2c.

The comparison of through-holes extracted from the inspection image T12 and circular areas in the comparison images MI2a˜MI2c may be carried out by comparing respective locations. If the distance between a circular area and an area representing a through-hole does not exceed a predetermined distance criterion (e.g. 5 pixels), it is determined that the circular area corresponds with the through-hole. It is also possible to carry out the comparison by some other method. For example, it is possible to generate an image representing circular areas extracted from the comparison images MI2a˜MI2c, and the through-holes compared with the circular areas by means of performing a logic operation on this image and the inspection image. In this case, by performing the AND operation of the inspection image TI2 and an image having a 0 only for the inside of the circular area in the comparison images MI2a, there can be obtained an image in which the area representing the through-hole TH5 of the inspection image T12 is replaced by white color (0). By performing successive AND operations on the image thus obtained and images having a 0 only for the inside of circular area in the comparison images MI2b and MI2c, an image as shown in FIG. 8F which represents the through-holes TH3, TH6 with defect can be obtained.

In this way, in the second embodiment as well, it is possible to detect through-hole defects by means of comparing a comparison image with an inspection image generated by segmentation of a color image.

In the second embodiment, the comparison image obtaining unit 240 designates the shape of the areas extracted from the segmentation result SR2 as the shape of a normal through-hole, i.e., circular, some other shape may be designated as the shape for extraction from the segmentation result. Generally, the shape of the area for extraction may be the shape of a specific region represented in the inspection image.

### C. Modifications

The present invention is not limited to the aforementioned embodiments and working examples, and may be reduced to practice in various other modes without departing from the scope and spirit thereof, such as the following modifications, for example.

### C1. Modification 1

The two defect detection procedures described in the first embodiment and the second embodiment need not be executed independently. It is acceptable to execute either of the two defect detection procedures. In this case, it is acceptable, for example, to use the defect detection procedure of the second embodiment to detect defects that is not detected with the defect detection procedure of the first embodiment. Conversely, it is also acceptable to use the defect detection procedure of the first embodiment to detect defects that is not detected with the defect detection procedure of the second embodiment. In preferred practice, the two defect detection procedures are combined in order to increase the accuracy of defect detection.

### C2. Modification 2

Application of the defect detection technique of the present invention is not limited for inspection of a through-hole in printed circuit board. It is also possible to apply the defect detection technique of the present invention to detection of a defect relating to a specific region of any object, when the specific region subject to the defect detection is represented by a particular color area in an image. For example, the technique is applicable for detection of a defect such as a defect in shape of mechanical parts and a defect in letters printed on an object.

### C3. Modification 3

In the first embodiment, as shown in FIG. 5B and FIG. 5D, the comparison image MI1 is generated as an image that can be compared with the inspection image TI1 in its entirety. On the other hand, in the second embodiment, as shown in FIG. 8B and FIG. 8C, the comparison image MI2a extracted from the green area GB is generated as an image that can be compared with a portion of the inspection image TI2. As will be understood from these embodiments, in the present invention, it is possible to use as the comparison image an image that can be compared with at least a part of an inspection image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of detecting a defect relating to a specific region among a plurality of color regions, using a color image of an object under inspection having the plurality of color regions, the method comprising the steps of:
(a) performing segmentation of the color image into areas according to colors;
(b) obtaining an inspection image representing a shape of the specific region from a result of the segmentation; and
(c) detecting a defect relating to the specific region by comparing the inspection image with a comparison image, the comparison image being comparable at least in part with the inspection image.

2. A method according to claim 1, wherein the step (c) includes the steps of
(1) obtaining the comparison image as an image representing a standard shape of the specific region;
(2) obtaining a comparison result image representing difference of the shape of the specific region from the standard shape based on the inspection image and the comparison image; and
(3) detecting the defect relating to the specific region by evaluating the comparison result image.

3. A method according to claim 2, wherein the step (2) has the step of obtaining the comparison result image by performing a logic operation on the inspection image and the comparison image.

4. A method according to claim 3, wherein the logic operation is exclusive OR operation.

5. A method according to claim 4, wherein the step (3) has the step of detecting the defect relating to the specific region by evaluating planar dimension of a defect area within the comparison result image, the defect area indicating difference of the inspection image and the comparison image.

6. A method according to claim 4, wherein the step (3) has the step of detecting the defect relating to the specific region by evaluating width of a strap-shape area within the comparison result image, the strap-shape appearing when size of the shape of the specific region differs from size of the standard shape.

7. A method according to claims 4, wherein the step (3) has the step of detecting the defect relating to the specific region by evaluating number of defect areas within the comparison result image, the defect areas indicating difference of the inspection image and the comparison image.

8. A method according to claims 2, wherein the step (2) has the step of selecting an optimum shift amount which minimizes displacement of the inspection image and the comparison image from among mutually different relative amounts, and correcting relative position of the inspection image and the comparison image according to the optimum shift amount.

9. A method according to claim 8, wherein the step (2) has the step of obtaining the comparison result image by performing a logic operation on the inspection image and the comparison image.

10. A method according to claim 9, wherein the logic operation is exclusive OR operation.

11. A method according to claim 10, wherein the step (3) has the step of detecting the defect relating to the specific region by evaluating planar dimension of a defect area within the comparison result image, the defect area indicating difference of the inspection image and the comparison image.

12. A method according to claim 10, wherein the step (3) has the step of detecting the defect relating to the specific region by evaluating width of a strap-shape area within the comparison result image, the strap-shape appearing when size of the shape of the specific region differs from size of the standard shape.

13. A method according to claims 10, wherein the step (3) has the step of detecting the defect relating to the specific region by evaluating number of defect areas within the comparison result image, the defect areas indicating difference of the inspection image and the comparison image.

14. A method according to claim 1, wherein the step (c) includes the steps of
obtaining the comparison image as an image representing a shape of one or more color regions different from the specific region based on the result of the segmentation;
extracting a corresponding area having a shape which is close to a predetermined proper shape of the specific region from the comparison image; and
detecting defects relating to the specific region by comparing an area representing the specific region within the inspection image and the corresponding area within the comparison image.

15. A method of detecting a defect relating to a specific region among a plurality of color regions, using a color image of a printed circuit board having the plurality of color regions, the specific region being a through-hole provided in the printed circuit board, the method comprising the steps of:
(a) performing segmentation of the color image into areas according to colors;
(b) obtaining an inspection image representing a shape of the specific region from a result of the segmentation; and
(c) detecting a defect relating to the specific region by comparing the inspection image with a comparison image, the comparison image being comparable at least in part with the inspection image.

16. A method according to claim 15, wherein the step (c) includes the steps of
obtaining the comparison image as an image representing a standard shape of the specific region;
obtaining a comparison result image representing difference of the shape of the specific region from the standard shape based on the inspection image and the comparison image; and
detecting the defect relating to the specific region by evaluating the comparison result image.

17. A method according to claim 15, wherein the step (c) includes the steps of
obtaining the comparison image as an image representing a shape of one or more color regions different from the specific region based on the result of the segmentation;
extracting a corresponding area having a shape which is close to a predetermined proper shape of the specific region from the comparison image; and
detecting defects relating to the specific region by comparing an area representing the specific region within the inspection image and the corresponding area within the comparison image.

18. An apparatus of detecting a defect relating to a specific region among a plurality of color regions, using a color image of an object under inspection having the plurality of color regions, the apparatus comprising:
a segmentation unit configured to perform segmentation of the color image into areas according to colors;
an inspection image obtaining unit configured to obtain an inspection image representing a shape of the specific region from a result of the segmentation; and
a defect detecting unit configured to detect a defect relating to the specific region by comparing the inspection image with a comparison image, the comparison image being comparable at least in part with the inspection image.

19. An apparatus of detecting a defect relating to a specific region among a plurality of color regions, using a color image of a printed circuit board having the plurality of color regions, the specific region being a through-hole provided in the printed circuit board, the apparatus comprising:
a segmentation unit configured to perform segmentation of the color image into areas according to colors;
an inspection image obtaining unit configured to obtain an inspection image representing a shape of the specific region from a result of the segmentation; and
a defect detecting unit configured to detect a defect relating to the specific region by comparing the inspection image with a comparison image, the comparison image being comparable at least in part with the inspection image.
